(19) United States
(12) Patent Application Publication
(10) Pub. No.: US 2015/0347635 A1
(43) Pub. Date: Dec. 3, 2015

(54) METHOD OF DESIGNING A STRONG LIGHTWEIGHT LAMINATE

(71) Applicant: E. I. DU PONT DE NEMOURS AND COMPANY, Wilmington, DE (US)

(72) Inventors: YUKI SHITANOKI, UTSONOMIYA (JP); STEPHEN J. BENNISON, WILMINGTON, DE (US)

(21) Appl. No.: 14/721,372

(22) Filed: May 26, 2015

Related U.S. Application Data
(60) Provisional application No. 62/003,283, filed on May 27, 2014.

(51) Int. Cl. G06F 17/50

(52) U.S. Cl. CPC G06F 17/50

(57) ABSTRACT

Provided herein is a method of designing a strong lightweight laminate. This method uses effective thickness principles to calculate the structure of a laminate that has strength equal to that of a monolith of equal thickness. In a preferred application of the method, safety glass laminates are designed. The safety glass laminates have lower areal weight at equal strength, compared to a monolithic glass sheet of thickness equal to that of the safety glass laminate.

### CROSS-REFERENCE TO RELATED APPLICATION

This application claims priority under 35 U.S.C. §119 to U.S. Provisional Appln. No. 62/003,283, filed on May 27, 2014, which is incorporated herein by reference in its entirety.

### FIELD OF THE INVENTION

Provided herein is a method of designing a strong lightweight laminate. This method uses effective thickness principles to calculate the structure of a laminate that has equal strength and lighter weight compared to a target monolith. In a preferred application of the method, safety glass laminates are designed. The safety glass laminates have lower areal weight at equal strength, compared to a monolithic glass sheet of thickness equal to that of the safety glass laminate.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

The search for lighter, stronger materials remains an important goal in engineering. It has long been recognized that a combination of complementary materials may improve the performance of a structural component. For example, reinforced concrete uses the high strength and flexibility of steel bars to balance the brittleness of concrete. In another example, a polymeric interlayer having a good tensile strength provides needed toughness to a glass laminate.

Improving structural materials such as glass, metal, concrete, ceramics and polymer-mineral composites by reducing their weight while maintaining their strength yields many advantages. In any structural component of a vehicle, for example, reducing weight yields direct fuel economies. Alternatively, structures may be made more economically, for example when a relatively inexpensive polymer replaces some portion of a specialty metal or ceramic.

Accordingly, there remains a need to develop new thinner or lightweight laminates that have adequate strength for use in a wide variety of structures, including buildings, vehicles and safety glass laminates.

### SUMMARY OF THE INVENTION

Provided herein is a method of designing strong lightweight laminates using effective thickness principles. First, the basic material is selected. Based on its physical properties and the requirements of the structure, a thickness is selected for a monolith of the basic material. For example, the design of a large storage tank may require stainless steel having a certain thickness. Next, a candidate for an interlayer is selected, for example a rigid polymer such as polycarbonate, or a lightweight ceramic. A shear transfer coefficient Γ is calculated for the steel/interlayer/steel laminate using the Woelfel-Bennison approach described in the following references, for example: Calderone I., Davies P. S., Bennison S. J., Huang X., Gang L. “Effective laminate thickness for the design of laminated glass,” Proceedings of the Glass Performance Days, Tampere, Finland (2009); Galuppi L., Royer-Carfagni G. “Effective Thickness of Laminated Glass Beams. New expression via a Variational Approach,” Engineering Structures, 38, 53-67 (2012); and Galuppi L., Manara G., Royer-Carfagni G., “Practical expressions for the design of laminated glass,” Composites Part B: Engineering, 45 (1), 1677-1688 (2013). A weight reduction target is selected.

Using the appropriate graph in FIGS. 2 through 6(b), the intersection of the value of the shear transfer coefficient Γ and the curve for the targeted weight reduction provides the ratio s of the thicknesses of the interlayer and the outer layers. Another mathematical relationship provides the thicknesses of the individual layers. Because the Woelfel-Bennison approach is followed, the strength of the steel/interlayer/steel laminate is the same as that of the monolithic steel at equal thickness.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. A is a cross-sectional view of a monolithic sheet.

FIG. B is a cross-sectional view of a laminate.

FIG. 1 is a graph of s vs. Γ for deflection matching weight reduction (k=1). The arrow indicates “Maximum: s=7.41, Γ=1, Weight Reduction=36.0%.”

FIG. 2 is a graph of s vs. Γ for stress matching weight reduction (k=1). The arrow indicates “Maximum: s=4.45, Γ=1, Weight Reduction=30.2%.”

FIG. 3 is a graph of s vs. Γ for deflection matching weight reduction (k=1.5). The arrow indicates “Maximum: s=9.38, F=1, Weight Reduction=30.1%.”

FIG. 4(a) is a graph of s vs. Γ for stress matching weight reduction (k=1.5, pattern.1). The arrow indicates “Maximum: s=4.25, Γ=1, Weight Reduction=23.8%.”

FIG. 4(b) is a graph of s vs. Γ for stress matching weight reduction (k=1.5, pattern. 2). The arrow indicates “Maximum: s=5.45, Γ=1, Weight Reduction=33.9%.”

FIG. 5 is a graph of s vs. Γ for deflection matching weight reduction ratio (k=2). The arrow indicates “Maximum: s=11.3, Γ=1, Weight Reduction=33.4%.”

FIG. 6(a) is a graph of s vs. Γ for stress matching weight reduction ratio (k=2, pattern.1). The arrow indicates “Maximum: s=4.29, Γ=1, Weight Reduction=17.9%.”

FIG. 6(b) is a graph of s vs. Γ for stress matching weight reduction ratio (k=2, pattern.2). The arrow indicates “Maximum: s=6.56, Γ=1, Weight Reduction=35.1%.”

FIG. 7 is a perspective view of a four point bend test apparatus, including the test beam. Stress and deflection are measured at the center of the bottom side of the lower glass ply (dashed arrow). L₁=200, L₂=100, L₃=50, b=100.

### DETAILED DESCRIPTION OF THE INVENTION

The following definitions apply to the terms as used throughout this specification, unless otherwise limited in specific instances.

Moreover, unless otherwise defined, all technical and scientific terms used herein have the same meaning as commonly understood by one of ordinary skill in the art to which this invention belongs. In case of conflict, the present specification, including the definitions herein, will control.

Although methods and materials similar or equivalent to those described herein can be used in the practice or testing of the invention, suitable methods and materials are described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise in limited circumstances. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

Moreover, where a range of numerical values is recited herein, unless otherwise stated in specific circumstances, the range is intended to include the endpoints thereof, and all integers and fractions within the range. It is not intended that the scope of the invention be limited to the specific values recited when defining a range. Finally, when the term “about” is used in describing a value or an end-point of a range, the disclosure should be understood to include the specific value or end-point referred to.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

As used herein, the terms “comprises,” “comprising,” “includes,” “including,” “containing,” “characterized by,” “has,” “having” or any other synonym or variation thereof refer to a non-exclusive inclusion. For example, a process, method, article, or apparatus that is described as comprising a particular list of elements is not necessarily limited to those particularly listed elements but may further include other elements not expressly listed or inherent to such process, method, article, or apparatus.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where an invention or a portion thereof is described with an open-ended term such as “comprising,” it is to be understood that, unless otherwise stated in specific circumstances, this description also includes a description of the invention using the term “consisting essentially of” as they are defined above.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

The materials, methods, and examples herein are illustrative only and, except as specifically stated, are not intended to be limiting.

More particularly, the term “monolithic”, as used herein, refers to a sheet, layer or block fabricated of a single bulk material and having uniform properties throughout its mass, for example a glass sheet, a concrete layer, or a metal block.

The term “laminate”, as used herein alone or in combined form, such as “laminated” or “lamination” for example, refers to a structure having at least two layers that are adhered or bonded firmly to each other. The layers may be adhered to each other directly or indirectly. “Directly” means that there is no additional material, such as an interlayer or an adhesive layer, between the two layers, and “indirectly” means that there is additional material between the two layers.

The symbol “l” as used herein, for example to describe a laminate structure such as “glass/interlayer/glass”, refers to direct contact between the entire surface of two adjacent layers in the laminate.

The term “areal density” as used herein refers to the weight of a laminate divided by its projected surface area. For example, in a laminate that has the shape of a rectangular prism, the projected surface area is the product of the length and width of the laminate, and does not include the surface areas of the laminate's sides and bottom.

The term “effective thickness,” as used herein refers to the actual thickness of a monolithic glass beam having a bending stiffness that is equal to that of a laminated beam having the structure “material/interlayer/material”.

The effective thickness can be used in place of the laminate's actual thickness in analytic equations for the deformation of laminated beams.

Provided herein is a method of designing strong lightweight laminates. In this method, the mechanical properties of laminates having the structure “material/interlayer/material” are modelled using effective thickness principles. More specifically, effective thickness principles are based on the shear coupling Γ between the two plies of material through the interlayer. The shear coupling Γ, in turn, depends primarily on the interlayer's shear stiffness or modulus, the interlayer's material properties, and the laminate's geometry and length scale. In general terms, it is known that many interlayers are polymeric, and thus less dense than many structural materials, such as glass, metals and ceramics; therefore, material/polymer/material laminates are lighter than monolithic sheets having the same thickness. In addition, it is known that the material/polymer/material laminates and the monolithic sheets having the same thickness may not be equal in bending stiffness. More particularly, the conditions under which the Wolfel theory is applicable have now been found. Specifically, Equation (A) is a determinant equation describing the relationship of the ratio s of interlayer/material thickness and that of the moduli of the interlayer Eᵢₙₜ and the material Eₘₜₗ.

$$\frac{{E}_{int}}{{E}_{mtl}} \frac{{s}^{3}}{6 {s}^{2} + 12 s + 9} \leq 0.03 \qquad ( A )$$

It has now surprisingly been found, however, that the amount of the weight reduction that is attainable by material/polymer/material laminates compared to monolithic sheets of material can be calculated, when the laminate has equal strength and lighter weight compared to the target monolith.

Referring now to the drawings, wherein like reference numerals designate corresponding structure throughout the views, and referring in particular to FIG. A, a monolith of basic or “structural” material 100 is depicted. The monolith 100 may be made of any basic or “structural” material including, without limitation, glass; metal; ceramic; concrete; minerals such as granite, marble, limestone, and mica; wood; composites of wood with polymers, for example cardboard and paper; cloth, for example nonwoven fiber mats; polymers; and composites of minerals and polymers.

In this connection, the term “glass” as used herein includes window glass, plate glass, silicate glass, sheet glass, low iron glass, tempered glass, tempered CeO-free glass, float glass, colored glass, specialty glass (such as glass that includes ingredients to control, e.g., solar heating), coated glass (such as glass sputtered with metals (e.g., silver or indium tin oxide) for solar control purposes), E-glass, Toroglass, and Solexia™ glass (available from PPG Industries, Inc., of Pittsburgh, Pa.). Such specialty glasses are disclosed in U.S. Pat. Nos. 4,615,989; 5,173,212; 5,264,286; 6,150,028; 6,340,646; 6,461,736; and 6,468,934, for example.

Referring now to FIG. B, a material/interlayer/material laminate 200 is depicted. In the method described herein, the outer layers 21 and 23 of the laminate 200 are made of the same structural material that is used in the monolith 100. Glass is a preferred rigid structural material. The laminate 200 need not be symmetrical, that is, the thickness of the first outer layer 21 need not be equal to that of the second outer layer 23. The interlayer 22 comprises a material that whose properties complement those of the structural material in the outer layers in some way. For example, a polymeric interlayer having a good tensile strength provides needed toughness to a safety glass laminate. Similarly, a polymeric interlayer having a good viscoelasticity can compensate brittleness of glass materials and add safety performance to glazing, for example by preventing the scattering of glass pieces upon breakage.

Suitable materials for the interlayer include the materials that are suitable for use in the monolith 100. Also suitable are less rigid materials, such as for example polymers having a modulus of 200 MPa to 600 MPa. In addition, Equation (A), above, may be used to identify materials that are suitable for use in the methods described herein. Specifically, Equation (A) may be used to identify a suitable range of moduli for candidate materials, based on the modulus of one selected material and in light of the parameter s, the ratio of layer thicknesses in the laminate 200.

Polymers are preferred interlayer materials, and particularly preferred are polycarbonates; polystyrenes; silicone elastomers; epoxy resins; polystyrenes; polyvinylchlorides; polyurethanes; polyethylene homopolymers and copolymers of ethylene with other alkenes, including metallocene-catalyzed materials such as linear low density polyethylenes; polyolefin block elastomers; ethylene acid copolymers such as those available under the trademark Nucrel® from E.I. du Pont de Nemours and Company of Wilmington, Del. (hereinafter “DuPont”); ionomers of ethylene acid copolymers such as those available from DuPont under the trademark SentryGlas®; poly(vinyl acetals) including poly(vinyl butyrals) such as those available from Kuraray America, Inc., of Houston, Tex., under the trademark Butacite®; copolymers of ethylene with polar comonomers such as vinyl acetate (for example, those available from DuPont under the trademark Elvax®) and alkyl (meth)acrylates including methyl acrylate and butyl acrylate (for example, those available from DuPont under the trademark Elvaloy®).

As is evident from the foregoing, the effective thickness principles described herein apply to a wide variety of laminates comprising a wide variety of materials. For convenience, however, the following discussion focusses on glass laminates having the structure “glass/interlayer/glass”, wherein the interlayer is polymeric.

Further provided herein is a method to design a lightweight laminate 200 in which the outer layers 21 and 23 have the same thickness (k=1). First, the shear transfer coefficient Γ is calculated using Equation (1).

$$Γ = \frac{1}{1 + 9.6 \frac{E}{{Gl}^{2}} \frac{ht}{2}} \qquad ( 1 )$$

In the Equation (1) and the other equations that are set forth herein, the following variables are assigned:
t: Interlayer 22 thickness,
h: Smaller glass 21 or 23 thickness,
k: Thickness ratio of two glass sheets 21 and 23 (in this case, k=1),
l: length scale (shortest bending direction),
E: Young's modulus of glass,
G: Shear modulus of an interlayer 22 to be tested for suitability.

The shear modulus of interlayer 22, G, is obtained by dynamic mechanical analysis (DMA) followed by time-temperature superposition and calculation of shear relaxation modulus. One specific methodology for measuring the shear modulus is described in S. J. Bennison, A. Jagota, and C. A. Smith, “Fracture of glass/poly.vinyl butyral/.Butacite®/laminates in biaxial flexure”, J. Am. Ceram. Soc. 1999; 82(7); 1761-1770.

Further in this connection, the parameters h and t are not determined at this step; however, they do not have a strong effect on the shear transfer coefficient Γ. Therefore, these calculations use ⅓ of the thickness of the target monolithic glass 100 thickness as tentative values for h and t.

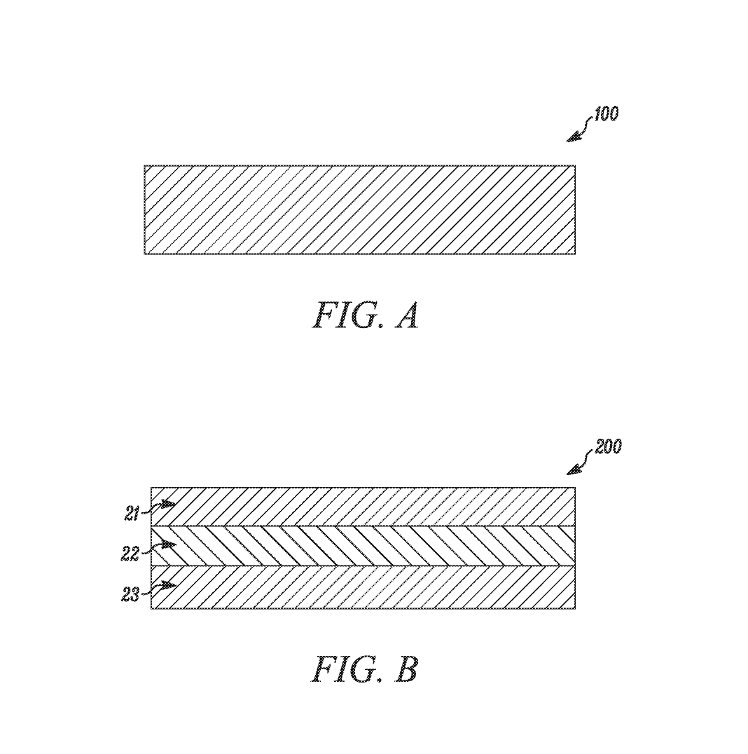

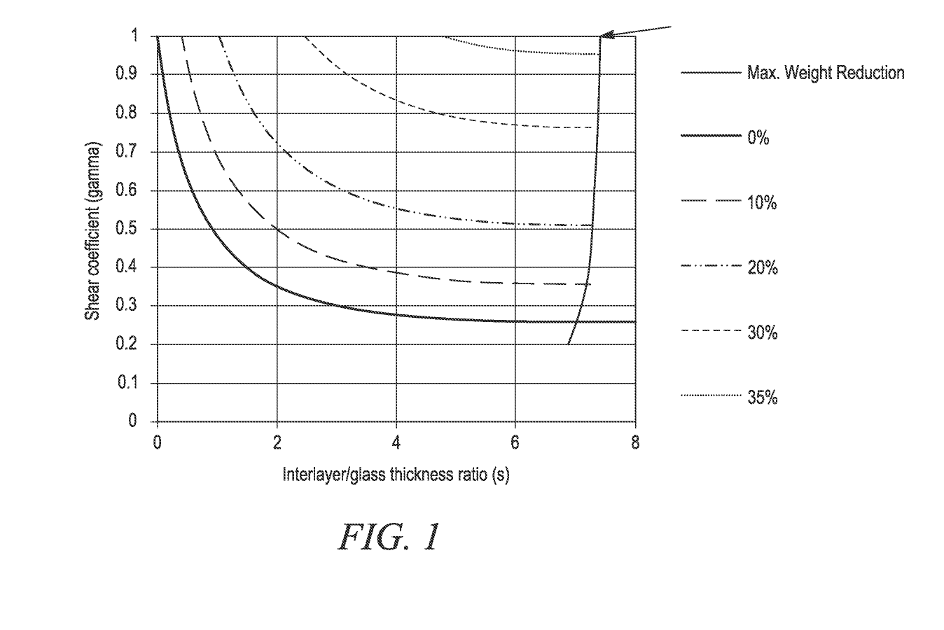

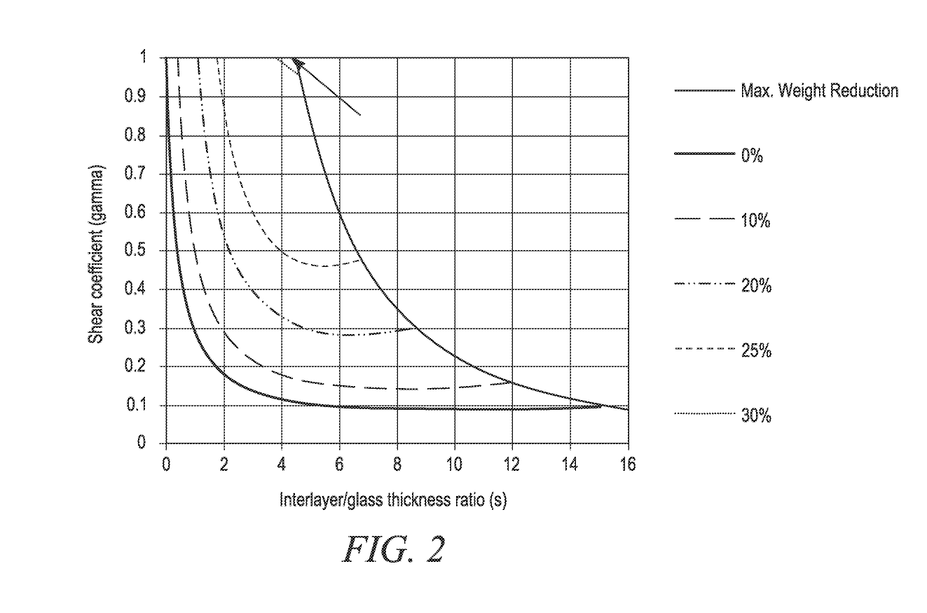

Once the value of Γ is determined, a desired weight reduction can be selected based on design criteria. Again, the weight reduction is the difference between the areal weight of the laminate 200 and the areal weight of the monolith 100. Using the shear transfer coefficient calculated by Equation (1) and the targeted weight reduction percentage, a value for thickness ratio s can be selected from the graphs in FIGS. 1 and 2. To maintain deflection performance equal to that of the monolith 100 (deflection matching), use the graph of FIG. 1. To maintain breakage resistance equal to that of the monolith 100 (stress matching), use the graph of FIG. 2.

The effective thickness of candidate structures can now be calculated by selecting some combinations of h and t that satisfy the thickness ratio s (=t/h) obtained from the appropriate graph. The effective thickness h_{ef} of the laminate 200 is determined using Equations (2) and (3).

For deflection matching, use Equation (2).

$${h}_{ef ; w} = \sqrt[3]{6 Γ {ht}^{2} + 12 Γ {h}^{2} t + ( 6 Γ + 2 ) {h}^{3}} \qquad ( 2 )$$

For stress matching, use Equation (3).

$${h}_{ef ; σ} = \sqrt{\frac{6 Γ {ht}^{2} + 12 Γ {h}^{2} t + ( 6 Γ + 2 ) {h}^{3}}{Γ t + ( 1 + Γ ) h}} \qquad ( 3 )$$

In an alternative approach, the targeted effective thickness h_{ef} can be used to calculate the exact thickness of outer layer thickness h necessary to achieve target stiffness, using Equations (2′) and (3′).

$$\begin{matrix}h = \frac{{h}_{ef ; w}}{\sqrt{6 Γ {s}^{2} + 12 Γ s + ( 6 Γ + 2 )}} & ( {2}^{′} ) \\ h = {h}_{ef ; σ} \sqrt{\frac{Γ s + ( 1 + Γ )}{6 Γ {s}^{2} + 12 Γ s + ( 6 Γ + 2 )}} & ( {3}^{′} )\end{matrix}$$

Finally, a structure for laminate 200 is selected whose effective thickness is same or larger than that of target monolithic glass. The interlayer thickness t can be calculated from the relationship t=sh. Significantly, however, the h and t determined in this approach are not necessarily viable in terms of commercial availability. Therefore, a practical design strategy may require that the layer thicknesses h and t be determined via an iterative process or otherwise fine-tuned.

Yet further provided herein is a method to design a lightweight laminate 200 in which the outer layers 21 and 23 have thicknesses that are related by the ratio k=1.5. Without wishing to be held to theory, it is believed that 1.5 is close to the maximum thickness ratio k that is practical in laminated glass. First, the shear transfer coefficient Γ is calculated using Equation (4).

$$Γ = \frac{1}{1 + 9.6 \frac{E}{{Gl}^{2}} \frac{k}{k + 1} ht} \qquad ( 4 )$$

Once more, these calculations use ⅓ of target monolithic glass 100 thickness as tentative values for h and t, for reasons set forth above with respect to the laminate 200 with k=1.

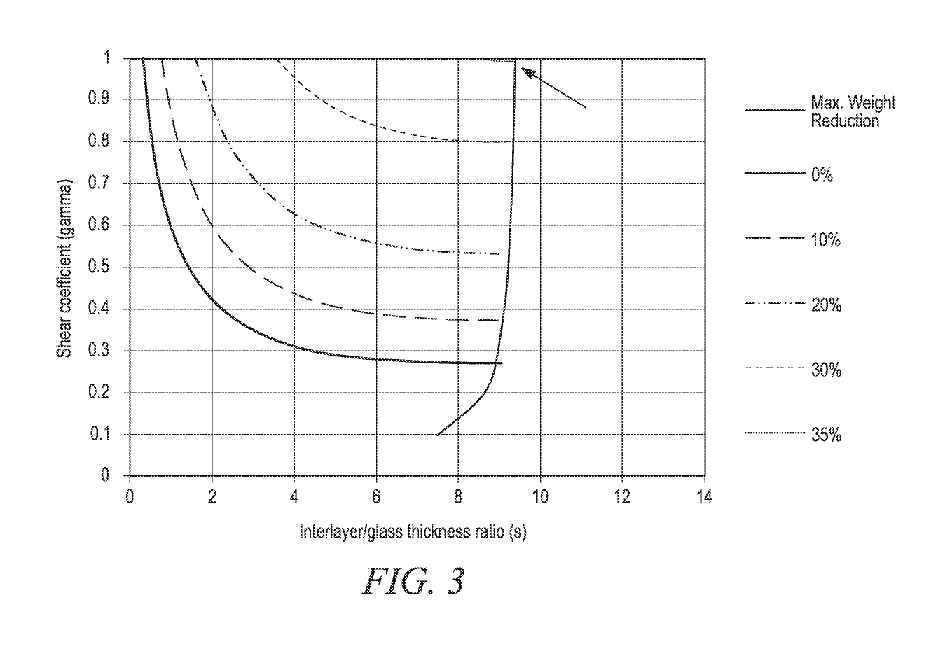

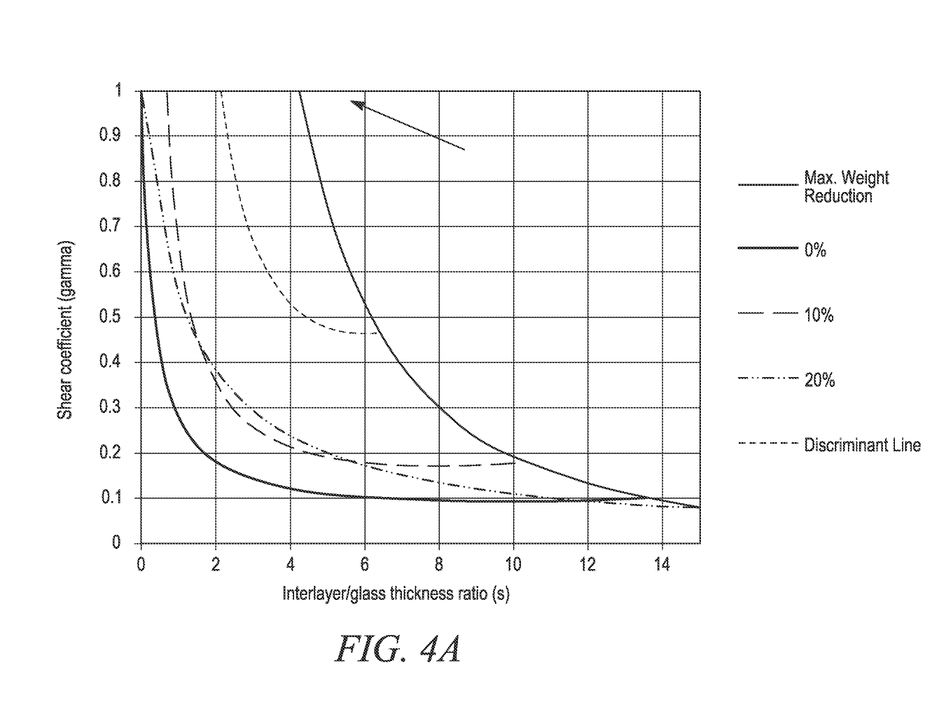

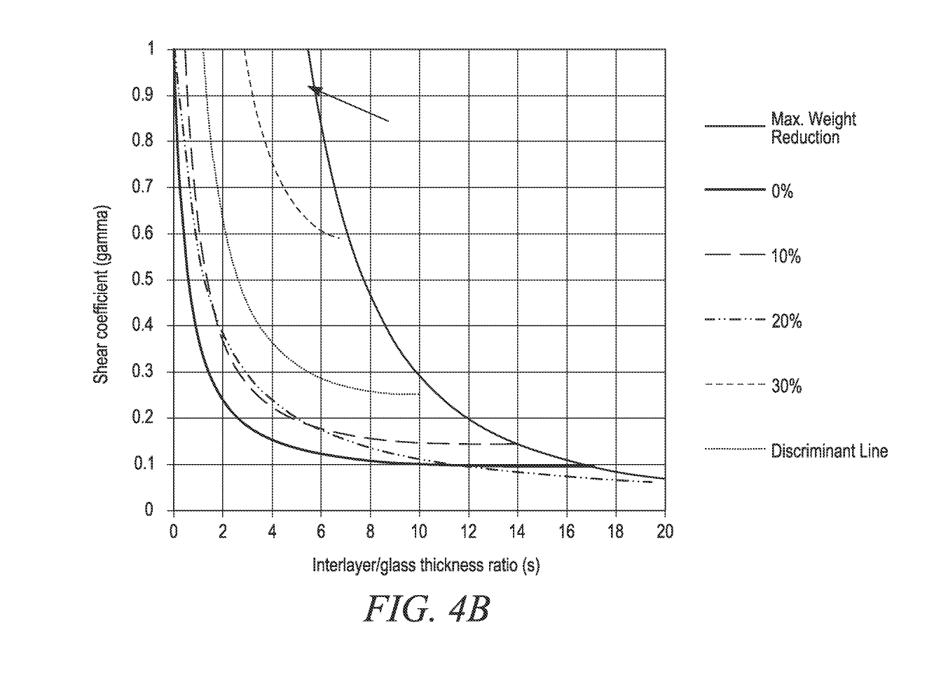

Once the value of Γ0 is determined, a desired weight reduction can be selected based on design criteria. Using the shear transfer coefficient calculated by Equation (4) and the targeted weight reduction percentage, a value for thickness ratio s can be selected from the graphs in FIGS. 3(a,b) and 4(a,b). To maintain deflection performance equal to that of the monolith 100 (deflection matching), use the graphs of FIGS. 3(a) and 3(b). To maintain breakage resistance equal to that of the monolith 100 (stress matching), use the graphs of FIGS. 4(a) and 4(b).

More specifically, because the thicknesses of the glass layers 21 and 23 are not equal, the stress at which laminate 200 will break depends on the direction from which the force is applied. Accordingly, for stress matching, FIG. 4(a) is used when the load is applied only from the thicker glass side of the laminate 200. FIG. 4 (b) is used when the load is applied only from the thinner glass side. If the load is applied from both sides of the laminate 200, use the area above the “discriminant line” in FIG. 4(a), or the area below the “discriminant line” in FIG. 4 (b). Likewise, for deflection matching, FIG. 3(a) is used when the load is applied only from the thicker glass side of the laminate 200. FIG. 3(b) is used when the load is applied only from the thinner glass side. If the load is applied from both sides of the laminate 200, use the area above the “discriminant line” in FIG. 3(a), or the area below the “discriminant line” in FIG. 3(b).

The effective thickness of candidate structures can now be calculated by selecting some combinations of h and t that satisfy the thickness ratio s (=t/h) obtained from the appropriate graph. The effective thickness h_{ef} of the laminate 200 is determined using Equations (5) and (6).

For deflection matching, use Equation (5).

$${h}_{ef ; w} = \sqrt[3]{{a}_{1} {ht}^{2} + {a}_{2} {h}^{2} t + {a}_{3} {h}^{3}} \qquad ( 5 )$$

For calculations of the maximum glass bending stress, use Equation (6).

$${h}_{ef ; σ} = \sqrt{\frac{{a}_{1} {ht}^{2} + {a}_{2} {h}^{2 } t + {a}_{3} {h}^{3}}{{a}_{4} t + {a}_{5} h}} \qquad ( 6 )$$

where

$${a}_{1} = \frac{12 k}{k + 1} Γ , \\ {a}_{2} = 12 Γ k , \\ {a}_{3} = ( 1 + {k}^{3} ) + 3 Γ ( 1 + k ) \\ {a}_{4} = \frac{2 k}{k + 1} Γ , \\ {a}_{5} = Γ k + 1 , \\ {a}_{6} = k + 1 \qquad ( 7 )$$

Alternatively, a₄ and a₅ may be calculated from Equation (7′):

$${a}_{4} = \frac{2}{k + 1} Γ , \\ {a}_{5} = Γ + k , \qquad ( {7}^{′} )$$

Equation (7) is used when the load is applied only from thicker glass side of the glass. Equation (7′) is used when the load is applied only from the thinner glass side. When the load is applied from both sides of the laminate, use Equation (7) when employing s in the upper area than “discriminant line”, or use Equation (7′) when employing s in the lower area than “discriminant line” in FIG. 4(b).

In an alternative approach, the targeted effective thickness h_{ef} can be used to calculate the exact thickness of outer layer thickness h necessary to achieve target stiffness, using Equations (5′) and (5′).

$$\begin{matrix}h = \frac{{h}_{ef ; w}}{\sqrt[3]{{a}_{1} {s}^{2} + {a}_{2} s + {a}_{3}}} & ( {5}^{′} ) \\ h = {h}_{ef ; σ} \sqrt{\frac{{a}_{4} s + {a}_{5}}{{a}_{1} {s}^{2} + {a}_{2} s + {a}_{3}}} & ( {6}^{′} )\end{matrix}$$

Finally, a structure for laminate 200 is selected whose effective thickness is same or larger than that of the targeted glass monolith. The interlayer thickness t can be calculated from the relationship t=sh. Once more, the h and t determined in this approach are not necessarily viable in terms of commercial availability. Therefore, a practical design strategy may require that the layer thicknesses h and t be determined via an iterative process or otherwise fine-tuned.

Yet further provided herein is a method to design a lightweight laminate 200 in which the outer layers 21 and 23 have thicknesses that are related by the ratio k=2. Without wishing to be held to theory, it is believed that 2 is close to the maximum thickness ratio k that is practical in laminated glass. First, the shear transfer coefficient Γ is calculated using Equation (4), above, with the same provisos set forth with respect to the method used when k=1.5.

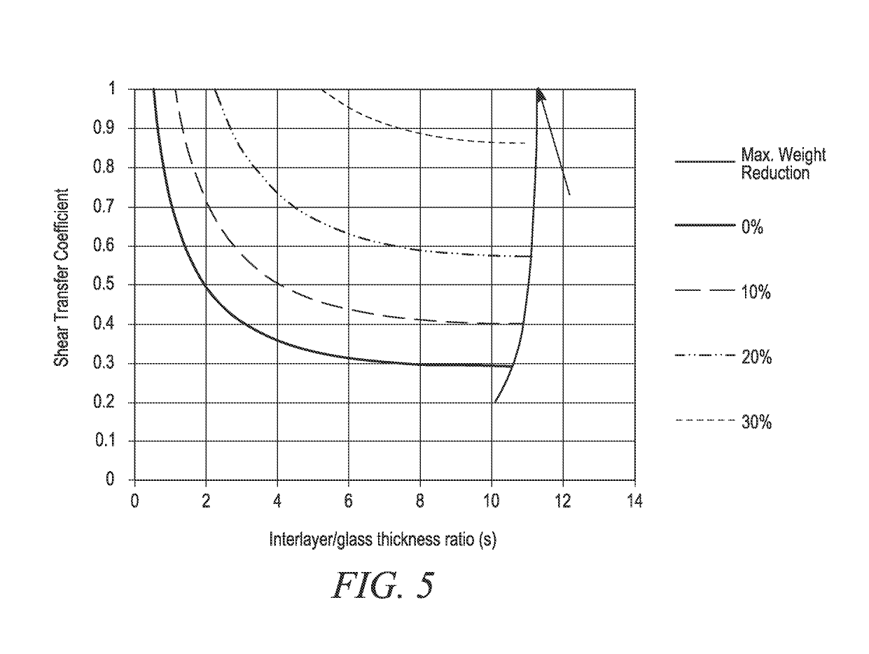

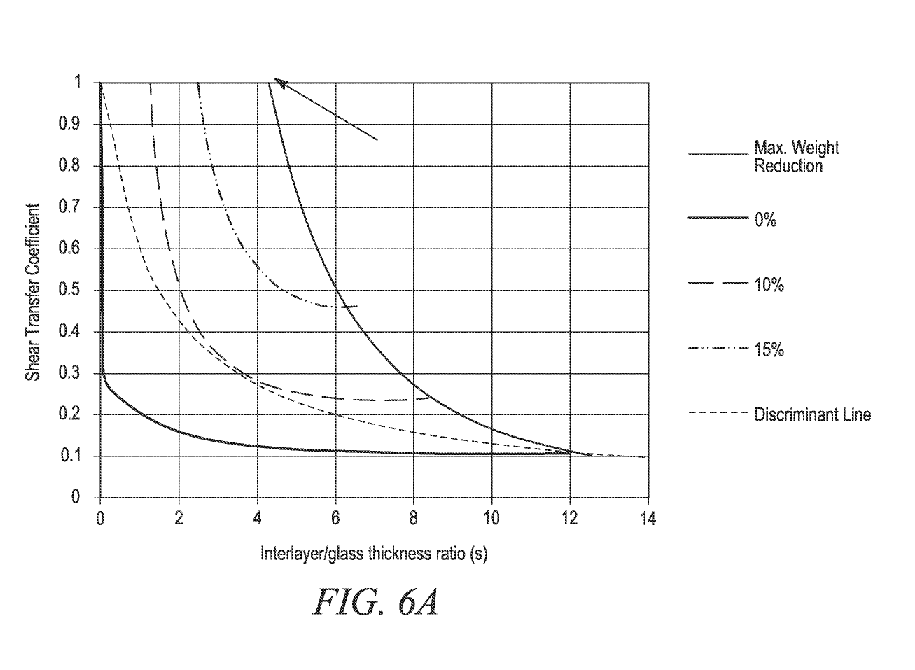

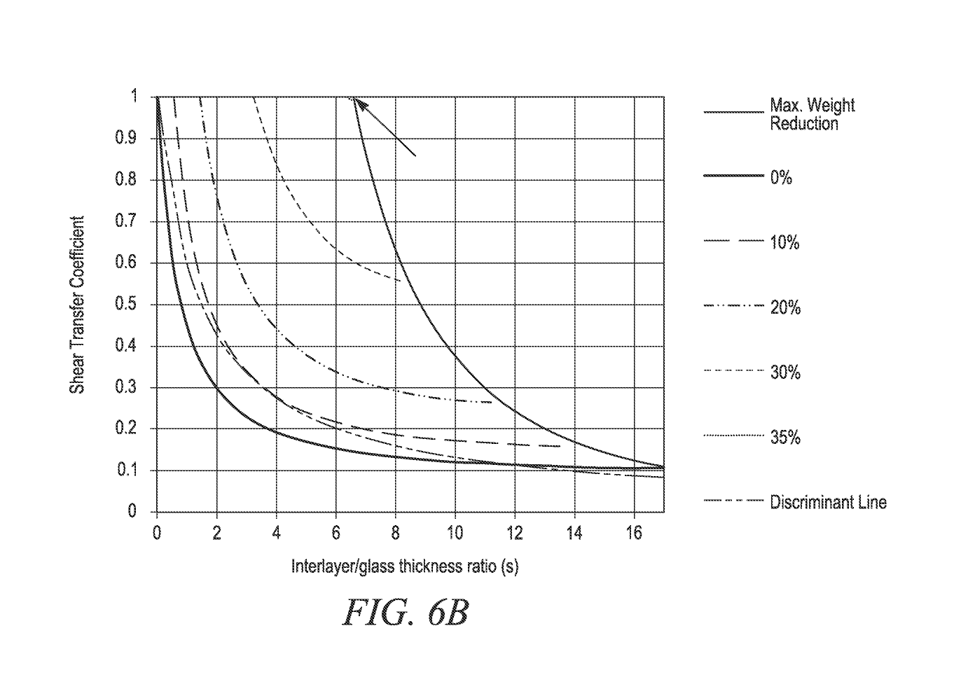

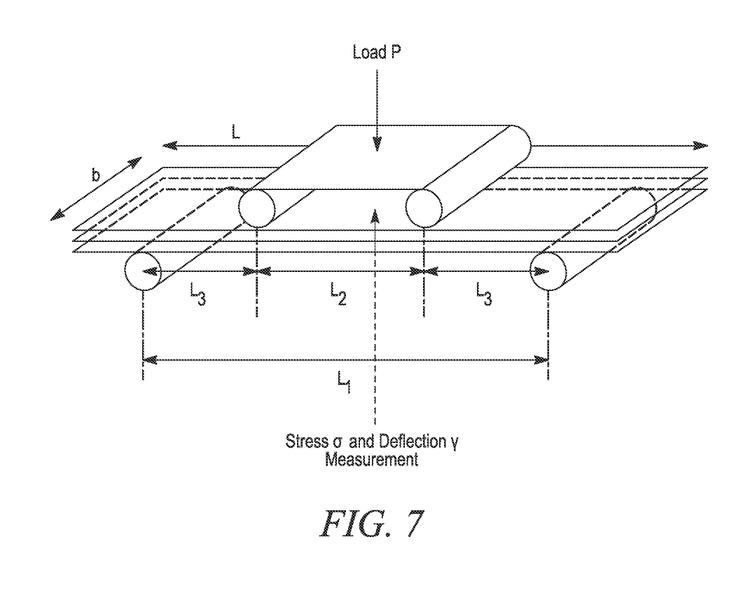

Once the value of Γ0 is determined, a desired weight reduction can be selected based on design criteria. Using the shear transfer coefficient Γ calculated by Equation (4) and the targeted weight reduction percentage, a value for thickness ratio s can be selected from the graphs in FIGS. 5(a,b) and 6(a,b). To maintain deflection performance equal to that of the monolith 100 (deflection matching), use the graphs of FIGS. 5(a) and 5(b). To maintain breakage resistance equal to that of the monolith 100 (stress matching), use the graphs of FIGS. 6(a) and 6(b).

More specifically, because the thicknesses of the glass layers 21 and 23 are not equal, the stress at which laminate 200 will break depends on the direction from which the force is applied. Accordingly, for stress matching, FIG. 6(a) is used when the load is applied only from the thicker glass side of the laminate 200. FIG. 6(b) is used when the load is applied only from the thinner glass side. If the load is applied from both sides of the laminate 200, use the area above the “discriminant line” in FIG. 6(a), or the area below the “discriminant line” in FIG. 6(b). Likewise, for deflection matching, FIG. 5(a) is used when the load is applied only from the thicker glass side of the laminate 200. FIG. 5(b) is used when the load is applied only from the thinner glass side. If the load is applied from both sides of the laminate 200, use the area above the “discriminant line” in FIG. 5(a), or the area below the “discriminant line” in FIG. 5(b).

As in the case in which k=1.5, above, the effective thickness h_{ef} is calculated from Equations (5), (6), (7) and (7′), and some combinations of h and t are selected that satisfy the thickness ratio s (=t/h) obtained from the appropriate graph. Equation (7) governs when the load is applied only from the side of the laminate 200 on which the glass layer 21 or 23 is the thicker layer, and Equation (7′) governs when the load is applied only from the side on which the glass layer 21 or 23 is the thinner layer. When the load is applied from both sides of the laminate 200, Equation (7) applies when employing s in the area above the “discriminant line”, or use the equation (7′) when employing s in the area below the “discriminant line” in FIG. 6(b).

Again, in an alternative approach, the targeted effective thickness h_{ef} can be used in Equation (5′) or (6′) to calculate the exact thickness of outer layer thickness h necessary to achieve the target stiffness. Finally, a structure for laminate 200 is selected whose effective thickness is same or larger than that of the targeted glass monolith. The same provisos set forth above with respect to smaller values of k also apply in this instance.

Further provided herein is a method to generate a graph of s vs. Γ for various values of k. First, when the deflection strength of the laminate 200 is matched to that of the monolith 100, the curves for a weight reduction of 100(1−W) % on a graph of s vs. Γ satisfy Equation 8:

pᵣ²s³+(3ρᵣ²a₄−a₁W³)s²+(3ρᵣa₄²−a₂W³)s+a₄³−a₃W³=0 (8)

For stress matching, Equation (9) pertains:

pᵣ²a₄s³+(2ρᵣa₆a₄+ρᵣ²a₅−2a₁W²)s²+(2ρᵣa₆a₅+ρᵣ²a₅+a₆²a₄−a₂W²)s+a₆²a₅−a₃W²=0 (9)

In Equations (8) and (9), a₁ through a₆ are calculated using Equation (7), above. The ratio of the density of the interlayer to the density of the outer layer material, ρᵣ², i.e., (density of polymeric interlayer)/(density of glass), is usually (0.95 g/cm³)/(2.5 g/cm³)=0.38.

When the deflection strength of the laminate 200 is matched to that of the monolith 100, the curves that indicate the maximum attainable weight reduction are shown as solid black lines in FIGS. 2 through 6(b). These curves satisfy Equation 10.

$$s = - ( \frac{{a}_{2}}{{a}_{1}} - \frac{{a}_{6}}{{ρ}_{r}} ) \pm \sqrt{{( \frac{{a}_{2}}{{a}_{1}} - \frac{{a}_{6}}{{ρ}_{r}} )}^{2} - 3 \frac{{a}_{3}}{{a}_{1}} + \frac{{a}_{2} {a}_{6}}{{a}_{1} {ρ}_{r}}} \qquad ( 10 )$$

For stress matching, Equation (11) pertains:

$${s}^{3} + 2 ( \frac{{a}_{2}}{{a}_{1}} - \frac{1}{{ρ}_{r}} ) {s}^{2} + ( \frac{{a}_{2} {a}_{5}}{{a}_{1} {a}_{4}} + 3 \frac{{a}_{3}}{{a}_{1}} - 4 \frac{{a}_{5}}{{a}_{4} {ρ}_{r}} ) s + 2 \{ \frac{{a}_{3} {a}_{5}}{{a}_{1} {a}_{4}} + \frac{1}{{ρ}_{r}} ( \frac{{a}_{3}}{{a}_{1}} - \frac{{a}_{2} {a}_{5}}{{a}_{1} {a}_{4}} ) \} \qquad ( 11 )$$

The discriminant line in stress matching is generated by Equation 12.

$$Γ = {( \frac{2 s}{k + 1} + 1 )}^{- 1} \qquad ( 12 )$$

Under this discriminant line, the values of a₄ and a₅ derived from Equation (7′) should be used.

Further provided herein are articles comprising the laminates 200 designed using the methods provided herein. The articles include, but are not limited to, buildings; other architectural structures; building panels; other components of architectural structures; storage tanks; vehicles such as boats, trains, airplanes, automobiles and trucks and components of the vehicles, such as, for example, door panels; and glass laminates for use as windshields, architectural safety glass, photovoltaic modules, and structural glass. Smaller objects, such as housings for computer equipment and household appliances such as microwave ovens, may comprise laminates of the invention. Also provided are handheld objects, such as smart phones and tablet computers, in which may the laminates may be touch screens or other components, such as housings or circuit boards.

The following examples are provided to describe the invention in further detail. These examples, which set forth a preferred mode presently contemplated for carrying out the invention, are intended to illustrate and not to limit the invention.

### Examples

### Consistency of Theory with Experiments

Test specimens of glass laminates shown in Table 1 were prepared. Standard soda-lime float glass was used for the glass plies, and DuPont™ SentryGlas® was used for the interlayer. A four point bending test (FIG. 8) was conducted using a general universal testing machine (Instron 5965). Deflection was measured by a linear variable differential transformer (LVDT) (Instron 2601-093) and stress was measured by strain gauges (Kyowa) located in the sample center of the bottom of the lower glass surface. Maximum principal stress was calculated by the Rosette analysis. Loading arm speed is 1 mm/min.

Comparable weight reduction percentage was calculated by the equations above from thickness ratio s and shear transfer coefficient Γ. For the shear modulus of SentryGlas®, 200 MPa (24° C., 1 s load duration) was used for calculation.
Shear transfer coefficient, s, and weight reduction percentages of laminate Nos. 1 to 5 in Table 1 fall within the range of FIGS. 1 and 2, which demonstrates the consistency of the methodology presented herein with the results of actual experiments.

TABLE 1
Comparison of experimental results with calculated results

| | Glass | | | | | | Weight Reduction | |
|---|---|---|---|---|---|---|---|---|
| | Thickness of | | | Shear | Effective Thickness | | Percentage (%) | |
| | one glass | Interlayer | | Transfer | (Experiment) | | (Experiment) | |
| No. | ply | Thickness | s | Coefficient | Deflection | Stress | Deflection | Stress |
| 1 | 0.55 | 0.97 | 1.76 | 0.98 | 1.95 | 1.90 | 24.7 | 22.6 |
| 2 | 0.55 | 2.53 | 4.60 | 0.95 | 3.14 | 2.99 | 34.4 | 31.1 |
| 3 | 0.55 | 4.31 | 7.84 | 0.91 | 4.19 | 3.73 | 34.7 | 26.5 |
| 4 | 1.10 | 1.75 | 1.59 | 0.93 | 3.73 | 3.71 | 23.2 | 22.9 |
| 5 | 1.10 | 3.55 | 3.23 | 0.86 | 5.08 | 4.95 | 30.1 | 28.3 |
| 6 | 1.10 | 6.20 | 5.63 | 0.78 | 6.51 | 6.46 | 30.0 | 29.5 |

### Application Example

### Substitution of 4 mm Monolithic Glass by Glass Laminate with 25% Weight Reduction

Here we assume substitution of 4 mm monolithic glass by lighter weight glass laminate, reducing weight by about 25%. Further assumptions include:
Size of monolith and laminate is 1000 mm
The laminate glass should have equivalent stress resistant properties to 4 mm glass, i.e., stress matching conditions
The thickness of the glass outer layers of the laminate should be the same (k=1), so that the laminate stiffness is constant against load from both positive and negative load.
The interlayer is DuPont SentryGlas® and the shear modulus 200 MPa (24 deg.C, 1 s load duration) is used for calculation.
   The shear coefficient is calculated. Though it varies for glass and interlayer thickness, it is almost 1 in any case.

From FIG. 2, we can find s should be more than 2 to achieve more than 25% weight reduction. Possible structures are shown in Nos. 1 to 4 of Table 1. Weight reduction from equivalent stiffness monolithic glass is about 26% in any case. Among them, No. 4 has stiffness close to 4 mm monolithic glass.

Then a slight adjustment is made to reach 4 mm effective thickness in realistic structures. Since 1.1 mm thin glass is commercially available and the interlayer's thickness can be flexibly adjusted or selected from a variety of commercial offerings, 1.1 mm glass/2.1 mm SentryGlas®/1.1 mm glass is selected to be the best structure. About 25% weight reduction from 4 mm monolithic glass is confirmed from the following calculation.

In the alternative approach using Eqns. (2′) and (3′), h and t are calculated to be h=1.05, t=2.09. Here Γ is assumed to be approximately 1. A conservative design strategy yields the structure “1.1 glass/2.1 mm SentryGlas®/1.1 mm glass.”
Weight of 4 mm monolithic glass: 10 kg/m²
Weight of 1.1 mm glass/2.1 mm SentryGlas®/1.1 mm glass: 7.50 kg/m²
Weight reduction (from 4 mm monolithic): 25.05
Weight reduction (from 4.04 mm monolithic*): 27.0% *Equivalent monolithic glass to the “1.1 mm glass/2.1 mm SentryGlas®/1.1 mm glass” laminate in terms of stress resistance.

TABLE 2
Candidate structures for glass laminate that substitute 4 mm monolithic glass

| | | | | | | | h; ef; s: | | | Weight of | |
|---|---|---|---|---|---|---|---|---|---|---|---|
| | | | | G: Shear | | | Effective | | | monolithic | |
| | | h: Glass | | Modulus of | t: Interlayer | Γ: Sheer | Thickness | | | glass with | Wt. |
| | l: Size | Thickness | | interlayer | Thickness | Transfer | for Stress | s = | Wt. | same stiffness | Redn. |
| No | (mm) | (mm) | k | (MPa) | (mm) | Coeff. | (mm) | t/h | (kg/m²) | (kg/m2) | (%) |
| 1 | 1000 | 0.3 | 1.0 | 200 | 0.6 | 1.000 | 1.12 | 2.00 | 2.07 | 2.81 | 26.2 |
| 2 | 1000 | 0.5 | 1.0 | 200 | 1.0 | 0.999 | 1.87 | 2.00 | 3.45 | 4.68 | 26.2 |
| 3 | 1000 | 0.7 | 1.0 | 200 | 1.4 | 0.998 | 2.62 | 2.00 | 4.83 | 6.55 | 26.2 |
| 4 | 1000 | 1.0 | 1.0 | 200 | 2.0 | 0.997 | 3.74 | 2.00 | 6.90 | 9.35 | 26.2 |
| 5 | 1000 | 1.1 | 1.0 | 200 | 2.1 | 0.996 | 4.04 | 2.20 | 7.50 | 10.1 | 27.0 |

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of designing a strong lightweight laminate, said method comprising the steps of:
a. selecting a basic material and a thickness of a monolith of the basic material;
b. selecting an interlayer material;
c. calculating the shear transfer coefficient Γ of a laminate having the structure “material/interlayer/material”, wherein “material” represents an outer layer of the basic material, and wherein “interlayer” represents a layer of the interlayer material having a thickness;
d. selecting a ratio k of the thicknesses of the two outer layers, wherein k=1, k=1.5, or k=2;
e. selecting a target weight reduction percentage and a target effective thickness;
f. when k=1, using the graph of FIG. 1 to select a ratio of interlayer thickness to outer layer thickness, for a laminate having the same deflection as the monolith;
g. alternatively when k=1 using the graph of FIG. 2 to select a ratio of interlayer thickness to outer layer thickness, for a laminate having the same breakage resistance as the monolith;
h. when k=1, using Eqns. 2′ and 3′ to calculate the thickness of the outer layers and the thickness of the interlayer
i. when k=1.5, for a laminate having the same deflection as the monolith, using the graph of FIG. 3(a) for forces applied to the thicker outer layer or the graph of FIG. 3(b) for forces applied to the thinner outer layer to select a ratio of interlayer thickness to outer layer thickness;
j. alternatively when k=1.5, for a laminate having the same breakage resistance as the monolith, using the graph of FIG. 4(a) for forces applied to the thicker outer layer or the graph of FIG. 4(b) for forces applied to the thinner outer layer to select a ratio of interlayer thickness to outer layer thickness;
k. when k=2, for a laminate having the same deflection as the monolith; using the graph of FIG. 5(a) for forces applied to the thicker outer layer or the graph of FIG. 5(b) for forces applied to the thinner outer layer to select a ratio of interlayer thickness to outer layer thickness
l. alternatively when k=2, for a laminate having the same breakage resistance as the monolith, using the graph of FIG. 6(a) for forces applied to the thicker outer layer or the graph of FIG. 6(b) for forces applied to the thinner outer layer to select a ratio of interlayer thickness to outer layer thickness;
m. when k=1.5 or when k=2, using Eqns. 5′ and 6′ to calculate the thickness of the outer layers and the thickness of the interlayer.

2. The method of claim 1, omitting the steps of using Eqns. 2′ and 3′ or Eqns. 5′ and 6′ to calculate the thickness of the outer layers and the thickness of the interlayer, and further comprising the steps of:
n. setting the total thickness of the laminate equal to the thickness of the monolith;
o. calculating the relative thicknesses of the outer layers and the interlayer based on their ratio, s, as identified in the relevant graph; and
p. calculating the thicknesses of the outer layers based on the ratio of the two thicknesses.

3. The method of claim 1, further comprising the step of using Equation (A) to select the physical properties of the basic material and the interlayer material.

4. The method of claim 2, further comprising the step of using Equation (A) to select the physical properties of the basic material and the interlayer material.

5. The method of claim 1, wherein the basic material is selected from the group consisting of glass; metal; ceramics; concrete; minerals;
polymers; wood; composites of wood with polymers; cloth; and
composites of minerals and polymers.

6. The method of claim 1, wherein the interlayer material is selected from the group consisting of glass; metal; ceramics; concrete; minerals; polymers; wood; composites of wood with polymers; cloth; and composites of minerals and polymers.

7. The method of claim 1, wherein the interlayer material is a polymer having a modulus of 200 MPa to 600 MPa or a polymer selected from the group consisting of polycarbonates; polystyrenes; silicone elastomers; epoxy resins; polystyrenes; polyvinylchlorides; polyurethanes; polyethylene homopolymers and copolymers of ethylene with other alkenes; polyolefin block elastomers; ethylene acid copolymers; ionomers of ethylene acid copolymers; poly(vinyl acetals); and copolymers of ethylene with polar comonomers.

8. The method of claim 1, wherein the basic material is glass.

9. The method of claim 8, wherein the interlayer material is a polymer selected from the group consisting of ethylene acid copolymers, ionomers of ethylene acid copolymers, copolymers of ethylene and vinyl acetate, and poly(vinyl butyrals).

10. A method of using one or more of Equations (1) through (12) to design a strong lightweight laminate.

11. A method of designing a strong lightweight laminate, said method comprising the steps of:
a. selecting a basic material and a thickness of a monolith of the basic material;
b. selecting an interlayer material;
c. calculating the shear transfer coefficient Γ of a laminate having the structure “material/interlayer/material”, wherein “material” represents an outer layer of the basic material, and wherein “interlayer” represents a layer of the interlayer material having a thickness;
d. selecting a ratio k of the thicknesses of the two outer layers;
e. selecting a target weight reduction percentage W and a target effective thickness;
f. using Equations (7) and (8) to generate a curve for W on a graph of s vs. Γ,
g. using the intersection of the curve for W with the line for the value of the shear transfer coefficient Γ to select a ratio s of interlayer thickness to outer layer thickness, for a laminate having the same deflection as the monolith;
h. alternatively, using Equations (7) and (9) to generate a curve for W on a graph of s vs. Γ,
i. intersection of the curve for W with the line for the value of the shear transfer coefficient Γ to select a ratio s of interlayer thickness to outer layer thickness, for a laminate having the same breakage resistance as the monolith; and
j. using Equations (5′) and (6′) to calculate the thickness of the outer layers and the thickness of the interlayer.

12. The method of claim 11, omitting the step of using Equations (5′) and (6′) to calculate the thickness of the outer layers and the thickness of the interlayer, and further comprising the steps of:
q. setting the total thickness of the laminate equal to the thickness of the monolith;
r. calculating the relative thicknesses of the outer layers and the interlayer based on their ratio, s, as identified in the relevant graph; and
s. calculating the thicknesses of the outer layers based on the ratio of the two thicknesses.

13. The method of claim 11, further comprising the step of using Equation (A) to select the physical properties of the basic material and the interlayer material.

14. The method of claim 12, further comprising the step of using Equation (A) to select the physical properties of the basic material and the interlayer material.

15. The method of claim 11, wherein the basic material is selected from the group consisting of glass; metal; ceramics; concrete; minerals; polymers; wood; composites of wood with polymers; cloth; and composites of minerals and polymers.

16. The method of claim 11, wherein the interlayer material is selected from the group consisting of glass; metal; ceramics; concrete; minerals; polymers; wood; composites of wood with polymers; cloth; and composites of minerals and polymers.

17. The method of claim 11, wherein the interlayer material is a polymer having a modulus of 200 MPa to 600 MPa or a polymer selected from the group consisting of polycarbonates; polystyrenes; silicone elastomers; epoxy resins; polystyrenes; polyvinylchlorides; polyurethanes; polyethylene homopolymers and copolymers of ethylene with other alkenes; polyolefin block elastomers; ethylene acid copolymers; ionomers of ethylene acid copolymers; poly(vinyl acetals); and copolymers of ethylene with polar comonomers.

18. The method of claim 11, wherein the basic material is glass.

19. The method of claim 18, wherein the interlayer material is a polymer selected from the group consisting of ethylene acid copolymers, ionomers of ethylene acid copolymers, copolymers of ethylene and vinyl acetate, and poly(vinyl butyrals).
